(19) United States
(12) Patent Application Publication
(10) Pub. No.: US 2008/0147294 A1
(43) Pub. Date: Jun. 19, 2008

(54) Control device for internal combustion engine capable of preventing deterioration of emission characteristic when internal combustion engine is started

(76) Inventors: Mamoru TOMATSURI, Toyota-shi (JP); Kenji HAYASHI, Okazaki-shi (JP); Kazuya MIYAJI, Toyota-shi (JP)

Correspondence Address: KENYON & KENYON LLP, 1500 K STREET N.W., SUITE 700, WASHINGTON, DC, 20005, US

(21) Appl. No.: 12/000,385

(22) Filed: Dec. 12, 2007

(30) Foreign Application Priority Data
Dec. 19, 2006 (JP) 2006-341410 (P)

(51) Int. Cl. F02D 45/00

(52) U.S. Cl. 701/102

(57) ABSTRACT

An engine ECU carries out control of an intermittent operation of an engine mounted on a hybrid vehicle. The engine is provided with an EGR apparatus controlling a flow rate of an EGR gas by means of an EGR valve from downstream of a three-way catalytic converter through an EGR pipe. When an engine stop request is issued, the engine ECU allows the engine to operate at idle and stops actuation of EGR by outputting a control signal (valve-closing signal) to the EGR valve. Then, the engine ECU estimates a remaining amount of the EGR gas within an intake pipe based on an amount of intake air detected by an airflow meter or the like, and when the estimated remaining amount of the EGR gas is equal to or smaller than a prescribed value, the engine ECU performs engine stop processing.

This nonprovisional application is based on Japanese Patent Application No. 2006-341410 filed with the Japan Patent Office on Dec. 19, 2006, the entire contents of which are hereby incorporated by reference.

### FIELD OF THE INVENTION

The present invention relates to a control device for an internal combustion engine, and more particularly to a control device for an internal combustion engine in a vehicle including the internal combustion engine as a source of driving force.

### DESCRIPTION OF THE BACKGROUND ART

Japanese Patent Laying-Open No. 2004-100497 discloses an engine automatic stop and automatic re-start apparatus mounted on an idle stop vehicle in which an engine is automatically stopped when the vehicle temporarily stops such as stop at a red light.

According to the engine automatic stop and automatic re-start apparatus, the engine includes an exhaust gas recirculation apparatus (hereinafter EGR) recirculating a part of exhaust gas within an exhaust manifold again to an intake manifold, for reducing nitrogen oxide (NOx) and improving fuel efficiency. The engine automatic stop and automatic re-start apparatus has exhaust gas introduction means for introducing the exhaust gas into the intake manifold before automatic stop of the engine when a request for automatic stop of the engine is detected and exhaust gas holding means for holding the exhaust gas within the intake manifold until the engine is automatically re-started.

According to such a configuration, immediately after automatic re-start of the engine, a ratio of newly charged air introduced into a combustion chamber is decreased and an amount of combustible air substantially decreases, and hence overshoot of an engine speed is suppressed.

According to the engine automatic stop and automatic re-start apparatus disclosed in Japanese Patent Laying-Open No. 2004-100497 above, overshoot of an engine speed can be suppressed and the engine can smoothly be re-started, whereas combustion in the combustion chamber becomes slow and combustion characteristics deteriorate, which results in increase in exhaust emission.

In addition, such a phenomenon that air-fuel mixture in the combustion chamber is not ignited due to a low temperature or pressure in the combustion chamber, or what is called misfire, may occur. If misfire occurs, not only the engine speed lowers but also unburned air-fuel mixture is emitted into the exhaust manifold. Namely, deterioration of exhaust emission and adverse influence on an exhaust purifying catalyst are concerned.

In particular, a hybrid vehicle further including a motor as another source of driving force of the engine is controlled such that efficiency attains to highest as a result of automatic switching between drive by the engine and drive by the motor regardless of an amount of operation of an accelerator by a driver. Namely, the engine of the hybrid vehicle is intermittently driven even during running and stop control thereof is frequently carried out. Accordingly, considerable deterioration of the emission characteristic at the time of re-start of the engine described above is concerned. Aforementioned Japanese Patent Laying-Open No. 2004-100497, however, is silent about measures for improving such emission characteristics at the time of re-start of the engine.

### SUMMARY OF THE INVENTION

An object of the present invention is to prevent deterioration of an emission characteristic at the time of start of an internal combustion engine in a vehicle in which the internal combustion engine is intermittently operated.

According to the present invention, a control device for an internal combustion engine is a control device for an internal combustion engine in a vehicle including the internal combustion engine as a source of driving force. The internal combustion engine includes an intake pipe, a recirculation valve and an exhaust gas recirculation apparatus for recirculating a part of the exhaust gas into the intake pipe of the internal combustion engine through the recirculation valve. The control device includes an intermittent operation control unit temporarily performing processing for stopping the internal combustion engine in response to a request to stop the internal combustion engine received when a prescribed stop condition is satisfied after the start of operation of the vehicle, a recirculation gas control unit stopping an operation to recirculate the exhaust gas by the exhaust gas recirculation apparatus and a remaining gas amount determination unit determining whether a remaining amount of the exhaust gas within the intake pipe is smaller than a prescribed value. The intermittent operation control unit performs the processing for stopping the internal combustion engine in response to determination that the remaining amount of the exhaust gas within the intake pipe is smaller than said prescribed value, when the request to stop the internal combustion engine is received.

According to the control device for the internal combustion engine above, the internal combustion engine is temporarily stopped after the exhaust gas remaining in an intake system is removed, so that deterioration of the emission characteristic at the time of next start of the internal combustion engine can be prevented.

Preferably, the remaining gas amount determination unit estimates the remaining amount of the exhaust gas within the intake pipe at least based on an amount of intake air introduced into said intake pipe.

According to the control device for the internal combustion engine above, the remaining amount of the recirculation gas within the intake pipe can readily be estimated.

Preferably, the intermittent operation control unit starts the internal combustion engine when a prescribed stop cancel condition is satisfied. The recirculation gas control unit senses a combustion state in the internal combustion engine at the time of start of the internal combustion engine and starts the operation to recirculate the recirculation gas in response to the sensed combustion state being stable.

According to the control device for the internal combustion engine above, further, at the time of next start of the internal combustion engine, the exhaust gas recirculation apparatus is actuated after the combustion state is stabilized, so that deterioration of the emission characteristic at the time of start of the internal combustion engine can further reliably be prevented.

Preferably, the recirculation gas control unit senses the combustion state in the internal combustion engine based on at least one of fuel injection control in the internal combustion engine, ignition timing control in the internal combustion engine, and lapse of time since start of control at the time of start of the internal combustion engine.

According to the control device for the internal combustion engine above, the fact that the combustion state is stable can readily be estimated based on the content of other control means controlling the internal combustion engine.

Preferably, the vehicle further includes a source of driving force in addition to the internal combustion engine.

According to the control device for the internal combustion engine above, in the hybrid vehicle in which control for stopping the internal combustion engine is frequently carried out, deterioration of the emission characteristic can reliably be prevented.

According to the present invention, in the vehicle in which the internal combustion engine is intermittently operated, deterioration of the emission characteristic at the time of start of the internal combustion engine can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a configuration of a hybrid vehicle incorporating a control device for an internal combustion engine according to an embodiment of the present invention.

FIG. 2 is a schematic diagram of a configuration of an engine system controlled by an engine ECU serving as the control device for the internal combustion engine according to the embodiment of the present invention.

FIG. 3 is an enlarged view of a part of an EGR apparatus in FIG. 2.

FIG. 4 is an enlarged view of a part of an EGR valve of the EGR apparatus.

FIG. 5 is a flowchart for describing control for stopping the internal combustion engine according to the embodiment of the present invention.

FIG. 6 is a flowchart for describing control for starting the internal combustion engine according to the embodiment of the present invention.

FIG. 7 is a flowchart for describing means for sensing a combustion state in the internal combustion engine according to the embodiment of the present invention.

### DESCRIPTION OF THE PREFERRED EMBODIMENTS

An embodiment of the present invention will be described hereinafter in detail with reference to the drawings. In the drawings, the same or corresponding elements have the same reference characters allotted.

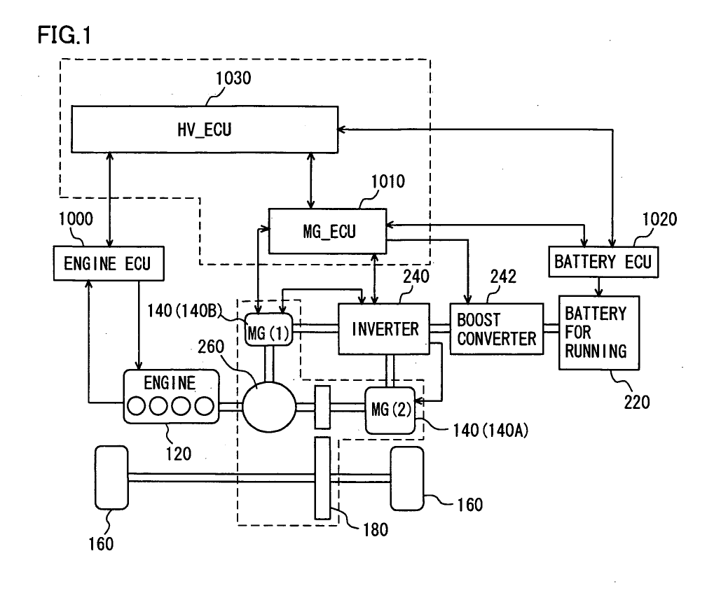

FIG. 1 is a block diagram illustrating a configuration of a hybrid vehicle representing an example of a vehicle incorporating a control device for an internal combustion engine according to an embodiment of the present invention. It is noted that the present invention is not limited to the hybrid vehicle shown in FIG. 1.

The hybrid vehicle includes an internal combustion engine (hereinafter simply referred to as an engine) serving as a drive source, such as a gasoline engine and a diesel engine, and a motor-generator (MG) 140. For the sake of convenience of illustration, in FIG. 1, motor-generator 140 is denoted as a motor 140A and a generator 140B (or motor-generator 140B), however, motor 140A may function as a generator or generator 140B may function as a motor, depending on a running state of the hybrid vehicle.

In addition to these elements, the hybrid vehicle includes: a reduction gear 180 transmitting motive power generated by engine 120 or motor-generator 140 to a drive wheel 160 and transmitting drive of drive wheel 160 to engine 120 or motor-generator 140; a power split device (such as a planetary gear mechanism) 260 distributing motive power generated by engine 120 to two paths of drive wheel 160 and generator 140B; a battery for running 220 charged with electric power for driving motor-generator 140; an inverter 240 carrying out current control by performing conversion between direct current of battery for running 220 and alternating current of motor 140A and generator 140B; a boost converter 242 performing voltage conversion between battery for running 220 and inverter 240; a battery control unit 1020 managing and controlling a charge/discharge state of battery for running 220 (hereinafter referred to as a battery ECU (Electronic Control Unit)); an engine ECU 1000 controlling an operation state of engine 120; an MG_ECU 1010 controlling motor-generator 140, battery ECU 1020, inverter 240, and the like in accordance with a state of the hybrid vehicle; an HV_ECU 1030 controlling the entire hybrid system through mutual management and control among battery ECU 1020, engine ECU 1000, MG_ECU 1010, and the like such that the hybrid vehicle can run most efficiently, and the like.

Though each ECU is configured separately in FIG. 1, an ECU implemented by integrating two or more ECUs together may be configured (for example, an ECU implemented by integrating MG_ECU 1010 and HV_ECU 1030 together, as shown with a dotted line in FIG. 1).

In power split device 260, a planetary gear mechanism (planetary gear) is employed in order to distribute motive power of engine 120 to both of drive wheel 160 and motor-generator 140B. By controlling a revolution speed of motor-generator 140B, power split device 260 also functions as a continuously variable transmission. Revolution force of engine 120 is input to a planetary carrier (C) and then transmitted to motor-generator 140B via a sun gear (S) and transmitted to the motor and an output shaft (drive wheel 160 side) via a ring gear (R). In stopping engine 120 that is revolving, as engine 120 is revolving, kinetic energy of revolution is converted to electric energy by means of motor-generator 140B, whereby the speed of engine 120 is decreased.

In the hybrid vehicle incorporating the hybrid system as shown in FIG. 1, if efficiency of engine 120 is poor at the time of start or during running at low speed, the hybrid vehicle runs solely by means of motor 140A of motor-generator 140. During normal running, for example, motive power of engine 120 is split into two paths by power split device 260. Namely, on one hand, drive wheel 160 is directly driven, and on the other hand, generator 140B is driven to generate electric power. Here, motor 140A is driven with the generated electric power, to assist drive of drive wheel 160. In addition, during running at high speed, electric power from battery for running 220 is further supplied to motor 140A to increase output of motor 140A, thereby providing additional driving force to drive wheel 160. On the other hand, in deceleration, motor 140A driven by drive wheel 160 functions as a generator to perform regeneration, and regenerated power is stored in battery for running 220. If a charged amount of battery for running 220 is low and charging is particularly necessary, output of engine 120 is increased to increase an amount of power generation by generator 140B, thereby increasing the charged amount of battery for running 220. Naturally, even during running at low speed, control for increasing an amount of drive of engine 120 is carried out as necessary, such as when charging of battery for running 220 is necessary as described above, when auxiliary machinery such as an air-conditioner is driven, and when a temperature of a coolant of engine 120 is raised to a prescribed temperature.

Thus, engine 120 of the hybrid vehicle is intermittently driven even during running, and stop control thereof is frequently carried out. Namely, engine ECU 1000 serving as the control device for the internal combustion engine implements the “intermittent operation control means” for intermittently operating engine 120.

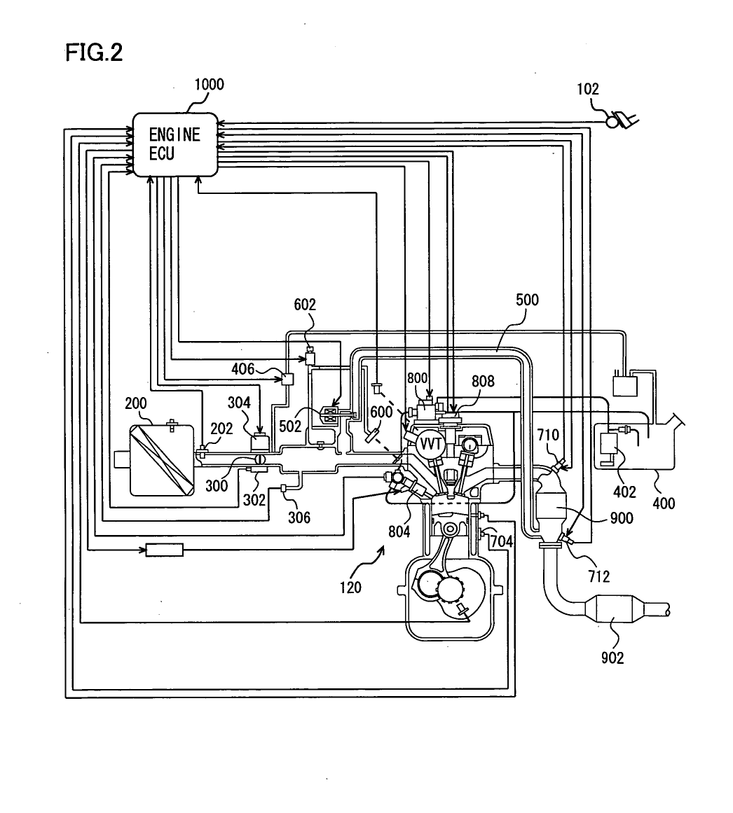

Engine 120 controlled by engine ECU 1000 serving as the control device for the internal combustion engine according to the embodiment of the present invention will now be described. FIG. 2 is a schematic diagram of a configuration of an engine system controlled by engine ECU 1000.

Referring to FIG. 2, in the engine system, air that passes through an air cleaner 200 is introduced into the combustion chamber of engine 120. Here, an amount of intake air is sensed by an airflow meter 202 and a signal indicating the amount of intake air is input to engine ECU 1000. In addition, the amount of intake air varies in accordance with a position of a throttle valve 300. The position of throttle valve 300 is varied by a throttle motor 304 actuated based on a signal from engine ECU 1000. A throttle position sensor 302 senses the position of throttle valve 300 and a signal indicating the position of throttle valve 300 is input to engine ECU 1000.

Fuel is stored in a fuel tank 400, delivered by a fuel pump 402 via a high-pressure fuel pump 800, and injected into the combustion chamber from a high-pressure fuel injector 804. Air-fuel mixture consisting of air introduced from an intake manifold and fuel injected from high-pressure fuel injector 804 into the combustion chamber from fuel tank 400 is ignited by an igniter-integrated ignition coil 808 receiving a control signal from engine ECU 1000 and the air-fuel mixture burns. In addition to such a configuration that an in-cylinder injector for injecting fuel into a cylinder is provided as in FIG. 2, the configuration may be such that an intake manifold injector for injecting fuel into an intake port and/or an intake manifold is provided or such that both of an in-cylinder injector and an intake manifold injector are provided.

The exhaust gas resulting from combustion of the air-fuel mixture passes through an exhaust manifold and emitted into atmosphere through a three-way catalytic converter 900 and a three-way catalytic converter 902.

As shown in FIG. 2, the engine system has an EGR apparatus controlling, by means of an EGR valve 502, a flow rate of an EGR gas from downstream of three-way catalytic converter 900 through an EGR pipe 500. The EGR apparatus is also referred to as an exhaust gas recirculation apparatus, and it aims at improvement in fuel efficiency by suppressing generation of nitrogen oxide (NOx) and suppressing pumping loss, by recirculating a part of the exhaust gas emitted from the engine to an intake system and mixing the exhaust gas with new air-fuel mixture to lower a combustion temperature.

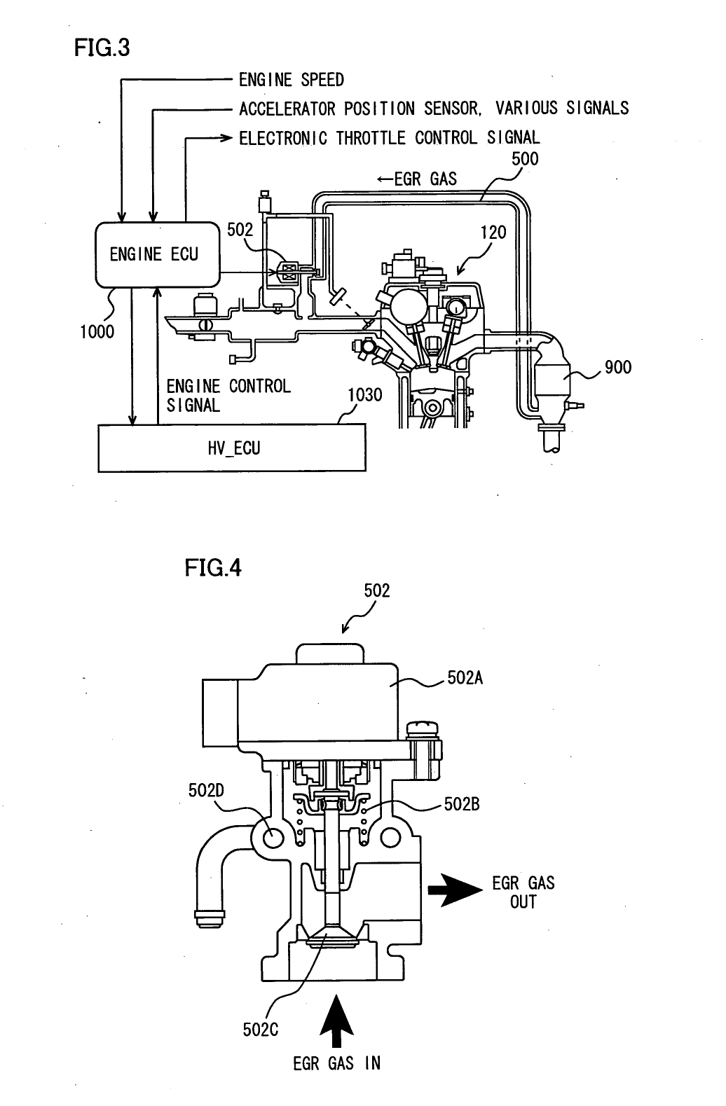

FIG. 3 is an enlarged view of a part of the EGR apparatus in FIG. 2, and FIG. 4 is an enlarged view of a part of EGR valve 502 of the EGR apparatus.

As shown in FIGS. 3 and 4, the exhaust gas that has passed through three-way catalytic converter 900 is introduced through EGR pipe 500 to EGR valve 502. Engine ECU 1000 carries out duty control of EGR valve 502. Engine ECU 1000 controls a position of EGR valve 502 based on an engine speed and various signals such as a signal from an accelerator position sensor 102.

In addition, as shown in FIG. 4, EGR valve 502 includes a stepping motor 502A operating in response to a control signal from engine ECU 1000, a poppet valve 502C of which position is controlled linearly by stepping motor 502A, and a return spring 502B. As the temperature of the EGR gas recirculated to the combustion chamber is high, the EGR gas adversely affects performance or durability of EGR valve 502. Therefore, a coolant passage 502D for cooling with an engine coolant is provided.

HV_ECU 1030 receives a signal indicating the engine speed sensed by an engine speed sensor (not shown) and a signal from accelerator position sensor 102, via engine ECU 1000. In addition, HV_ECU 1030 receives a signal indicating a vehicle speed sensed by a wheel speed sensor (not shown). HV_ECU 1030 outputs an engine control signal (such as a throttle position signal) to engine ECU 1000 based on these signals.

Engine ECU 1000 outputs an electronic throttle control signal to engine 120, based on the engine control signal or other control signals. In addition, when an engine stop instruction and an engine start instruction are issued, engine ECU 1000 generates a control signal for adjusting a position of EGR valve 502 with a method which will be described later, and outputs the generated control signal to stepping motor 502A.

In the present embodiment, EGR valve 502 in the EGR apparatus has been described as a valve in which poppet valve 502C is driven by stepping motor 502A, however, the present invention is not limited thereto. For example, a pneumatic control EGR valve implemented by a solenoid valve and a pneumatic actuator having a diaphragm, instead of an electric actuator such as stepping motor 502A, may be adopted.

Referring again to FIG. 2, in addition to such an EGR apparatus, systems as shown below are introduced in the engine system.

In the engine system, a fuel injection control system is introduced. A fuel injection amount is controlled based on detection of the amount of intake air by airflow meter 202 and a vacuum sensor 306. Engine ECU 1000 controls the fuel injection amount and fuel injection timing in accordance with an engine speed and engine load so as to attain an optimal combustion state, based on a signal from each sensor.

In addition, in the engine system, the fuel injection amount is determined based on the engine speed and the amount of intake air (detected by vacuum sensor 306 and airflow meter 202). Moreover, an air-fuel ratio after the start is subjected to feedback control based on a signal from oxygen sensors 710 and 712. Namely, in fuel injection control, fuel injection timing control and injection amount control are carried out by correcting, based on the signal from each sensor, basic injection timing operated in accordance with the engine state.

In addition, in the engine system, an ignition timing control system is introduced. Engine ECU 1000 calculates optimal ignition timing based on the signal from each sensor and outputs an ignition signal to igniter-integrated ignition coil 808. The ignition timing is determined based on initially set ignition timing or on a basic advance angle and a corrected advance angle. Moreover, in the engine system, a knock control system, in which when a knock sensor 704 senses knocking, ignition timing is retarded by a certain angle until knocking no longer occurs, and when knocking no longer occurs, the ignition timing is advanced by a certain angle, is introduced.

Engine ECU 1000 calculates the ignition timing of the engine in accordance with the operation state, based on an engine speed signal, a signal from a cam position sensor, a signal indicating a flow rate of intake air, a throttle valve position signal, a signal for an engine coolant, and the like, and outputs an ignition signal to igniter-integrated ignition coil 808. Namely, in ignition timing control, appropriate ignition timing is calculated by correcting, based on the signal from each sensor, the basic ignition timing operated in accordance with the engine state.

In addition, in the engine system, a throttle control system is introduced. Under control by the throttle control system, an appropriate position of throttle valve 300 is set by correcting, based on the signal from each sensor, a position thereof operated in accordance with the engine state. Namely, engine ECU 1000 controls a position of throttle valve 300 with the use of throttle motor 304, such that an appropriate position of throttle valve 300 in accordance with the combustion state in the engine is set.

In addition, in the engine system, an idle speed control system is introduced. The idle speed control system controls a fast idle speed in accordance with an engine coolant temperature and an idle speed after warming up of the engine. In idle speed control, the amount of intake air is calculated based on the signal from airflow meter 202 and vacuum sensor 306, and engine ECU 1000 calculates an optimal position of throttle valve 300 and optimal injection timing, thereby bringing the idle speed to a target speed.

Though not shown in FIG. 2, in addition to control of the idle speed by using a throttle motor, a control method using an idle speed control valve is also available. The idle speed control valve controls the idle speed by regulating an amount of air that flows through a bypass passage of the throttle valve.

In addition, in the engine system, a canister purge control system is introduced. According to the canister purge control system, an evaporated fuel gas generated from fuel tank 400 is suctioned into an intake port and the fuel gas burns. An amount of canister purge is controlled in accordance with the operation state, under control by engine ECU 1000 of opening and closing of a canister purge VSV (Vacuum Switching Valve) 406. Here, engine ECU 1000 outputs a duty signal to canister purge VSV 406 to control a position of canister purge VSV 406.

In addition, in the engine system, an airflow control valve system is introduced. The airflow control valve system optimally controls airflow in the combustion chamber by closing one of two independent intake ports in accordance with an engine coolant temperature and an engine state, thus stabilizing combustion and improving performance. An airflow control valve 600 is provided on one side of the independent intake port, and opening and closing of this valve is controlled based on the signal from engine ECU 1000. By closing one port, a speed of flow of the intake air that passes through another port increases and turbulent flow in a lateral direction in the combustion chamber is strengthened. Thus, when the coolant temperature is low, atomization of fuel is promoted and combustion is stabilized. In addition, volume efficiency and combustion efficiency are improved even in a low-speed and high-load region, and thus high performance can be achieved. Engine ECU 1000 determines the position of airflow control valve 600 based on an engine speed, an engine coolant temperature, a load signal, and the like, and opens and closes airflow control valve 600 by switching a negative pressure applied to a diaphragm chamber of an actuator via a VSV 602 for the airflow control valve.

(Control of Intermittent Operation of the Engine)

As described above, in the hybrid vehicle incorporating the hybrid system shown in FIG. 1, as engine 120 is intermittently driven even during running, stop control thereof is frequently carried out.

In such control of the intermittent operation of engine 120, if the EGR gas recirculated by the EGR apparatus remains in the intake pipe at the time of start (re-start) of engine 120, combustion in the combustion chamber becomes slow and combustion characteristics deteriorate, which results in increase in exhaust emission.

In addition, such a phenomenon that air-fuel mixture in the combustion chamber is not ignited due to a low combustion temperature or pressure, or what is called misfire, may occur. If misfire occurs, not only the engine speed lowers but also unburned air-fuel mixture is emitted into the exhaust manifold. Namely, deterioration of the exhaust emission and adverse influence on an exhaust purifying catalyst are concerned.

Namely, in the engine system shown in FIG. 2, the EGR gas recirculated into the intake pipe achieves such effects as reduction in NOx and improvement in fuel efficiency during the engine operation in which combustion is stable, whereas at the time of engine start when combustion is unstable, the EGR gas turns out to be a factor to deteriorate emission characteristics.

The control device for the internal combustion engine according to the present invention is configured to control the operation of the EGR apparatus such that the EGR gas does not remain in the intake pipe at the time of start (re-start) of the engine while engine intermittent operation control is carried out.

More specifically, as a first configuration, in carrying out stop control of engine 120, engine ECU 1000 in the present embodiment carries out control for removing the EGR gas contained in the intake pipe. In response to removal of the EGR gas, engine ECU 1000 starts processing for stopping engine 120.

In addition, as a second configuration, in carrying out start control of engine 120, engine ECU 1000 carries out control for introducing the EGR gas into the intake pipe in response to the fact that combustion in engine 120 has been stabilized.

These two configurations implemented at the time of engine stop and engine start respectively will be described hereinafter in detail.

(Engine Stop Control)

Initially, the engine stop control is carried out in response to an engine stop request. When the engine stop request is issued, engine ECU 1000 allows engine 120 to operate at idle (no-load operation) for a prescribed period before the engine stops, as a part of the engine stop control. The present embodiment is configured to stop actuation of the EGR apparatus (EGR cut-off) for the prescribed period. Specifically, engine ECU 1000 stops actuation of the EGR apparatus by outputting a control signal (valve-closing signal) to EGR valve 502.

By thus closing EGR valve 502, only the air that passes through air cleaner 200 is introduced into the intake pipe. Accordingly, the introduced air expels the EGR gas from the intake pipe into the combustion chamber. In addition, as the exhaust gas resulting from combustion is entirely emitted into the atmosphere, the exhaust gas is not recirculated to the intake pipe.

Here, engine ECU 1000 estimates a remaining amount of the EGR gas contained in the intake pipe. For example, engine ECU 1000 operates an accumulated value of the amount of intake air detected by airflow meter 202 and vacuum sensor 306 during a prescribed period in which engine 120 operates at idle, and estimates the remaining amount of the EGR gas contained in the intake pipe based on the result of operation.

Then, when it is determined that the EGR gas has been removed from the intake pipe based on the estimated remaining amount of the EGR gas, engine ECU 1000 stops engine 120 and ends a series of stop control procedures. Namely, according to the present embodiment, processing for stopping engine 120 is prohibited until it is determined that the EGR gas has been removed. Thus, during a period in which engine 120 is temporarily stopped, the EGR gas is not contained in the intake system.

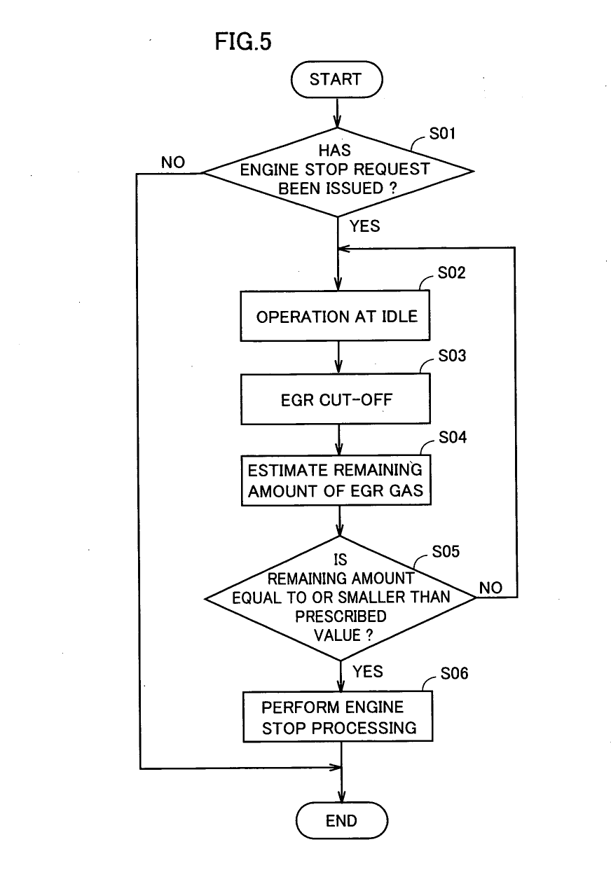

FIG. 5 is a flowchart for describing control for stopping the internal combustion engine according to the embodiment of the present invention.

Referring to FIG. 5, in step S01, engine ECU 1000 determines whether an engine stop request has been issued or not. In step S01, the engine stop request is issued when a prescribed engine stop condition is satisfied. In a vehicle in which the engine is intermittently operated as in the hybrid vehicle according to the present embodiment, the engine stop request is issued irrespective of a key operation by a driver.

If the engine stop request has been issued in step S01, engine ECU 1000 allows engine 120 to operate at idle (step S02) and outputs a control signal (valve-closing signal) to EGR valve 502 so as to stop actuation of EGR (EGR cut-off) (step S03). On the other hand, if the engine stop request is not issued in step S01, the process ends.

After EGR is cut off in step S03, engine ECU 1000 estimates the remaining amount of the EGR gas in the intake pipe based on the amount of intake air detected by vacuum sensor 306 and airflow meter 202 (step S04). Then, engine ECU 1000 determines whether the remaining amount of the estimated EGR gas is equal to or smaller than a prescribed value set in advance (step S05).

If the remaining amount of the EGR gas is equal to or smaller than the prescribed value in step S05, engine ECU 1000 performs the engine stop processing (step S06). On the other hand, if the remaining amount of the EGR gas exceeds the prescribed value, the process returns again to step S02 and causes engine 120 to continue operation at idle until the remaining amount of the EGR gas is equal to or smaller than the prescribed value.

By thus temporarily stopping engine 120 with the EGR gas having been removed from the intake pipe, engine 120 is maintained in a state where the EGR gas does not remain in the intake pipe during an operation stop period until next re-start of the engine. Then, engine ECU 1000 carries out control for re-starting engine 120 in response to the fact that a prescribed engine stop cancel condition is satisfied.

(Engine Start Control)

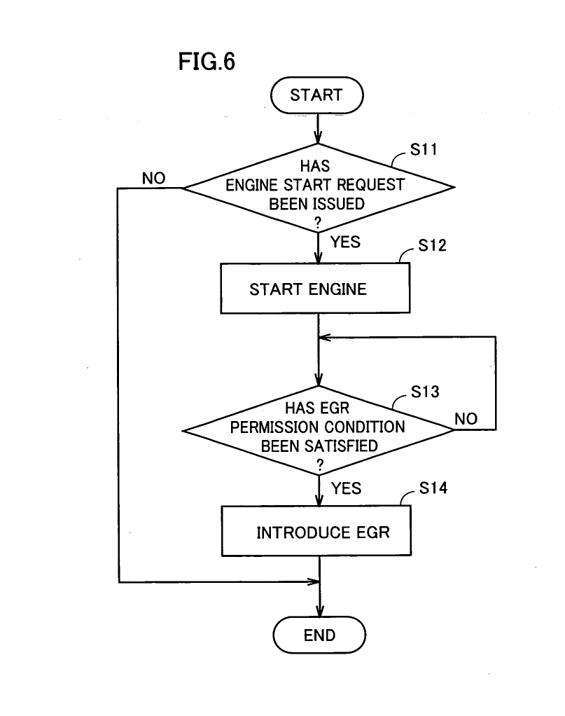

FIG. 6 is a flowchart for describing control for starting the internal combustion engine according to the embodiment of the present invention. It is noted that control procedures shown in the flowchart in FIG. 6 are carried out by engine ECU 1000 while engine 120 is in a stop state as a result of a series of engine stop control procedures shown in FIG. 5.

Referring to FIG. 6, in step S11, engine ECU 1000 determines whether an engine start request has been issued or not. In step S11, the engine start request is issued if the prescribed engine stop cancel condition is satisfied.

When the engine start request is issued in step S11, engine ECU 1000 starts engine 120 (step S12). On the other hand, when the engine start request is not issued in step S11, the process ends.

At the time of start of the engine, engine ECU 1000 further determines whether a prescribed EGR permission condition has been satisfied or not (step S13). The prescribed EGR permission condition refers to a condition for permitting actuation of EGR, and the prescribed EGR permission condition is set in advance such that it is satisfied when a stable combustion state in engine 120 is sensed, as will be described later.

If the EGR permission condition is satisfied in step S13, engine ECU 1000 starts actuation of the EGR apparatus (EGR introduction) (step S14). Specifically, engine ECU 1000 outputs a control signal (valve-opening signal) to EGR valve 502 to start actuation of the EGR apparatus.

On the other hand, if the EGR permission condition is not satisfied in step S13, engine ECU 1000 continues to stop actuation of the EGR apparatus until the EGR permission condition is satisfied.

When engine 120 is thus re-started after it is temporarily stopped, the EGR apparatus is not actuated until the combustion state in engine 120 is stabilized, so that the engine is started in such a state that the EGR gas does not remain in the intake pipe. Consequently, deterioration of the emission characteristic at the time of engine start can reliably be prevented.

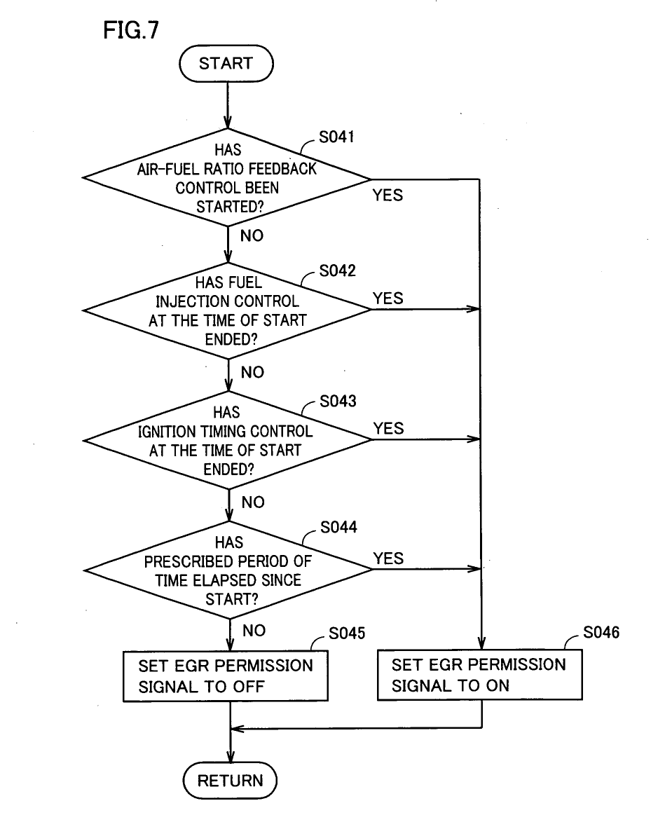

Here, the operation to determine whether the EGR permission condition has been satisfied or not in step S13 shown in FIG. 6 is performed based on a combustion state in engine 120, and for example, it is performed as shown in the flowchart in FIG. 7.

FIG. 7 is a flowchart for describing means for sensing a combustion state in the internal combustion engine according to the embodiment of the present invention.

Referring to FIG. 7, if at least one of the conditions shown in steps S041 to S044 is satisfied, engine ECU 1000 determines that the combustion state in engine 120 is stable and sets an EGR permission signal to be output to the EGR apparatus to ON (step S046). When the EGR permission signal is set to ON, actuation of the EGR apparatus is allowed. On the other hand, when the EGR permission signal is set to OFF, actuation of the EGR apparatus is not allowed.

Specifically, engine ECU 1000 senses the combustion state in engine 120 based on control content of various control systems introduced in the engine system shown in FIG. 2 and on lapse of time since the start.

As shown in FIG. 7, in step S041, engine ECU 1000 determines whether feedback control of the air-fuel ratio has been started or not. As described above, air-fuel ratio feedback control is configured as a part of the combustion injection control system such that it is carried out after the engine is started when the fuel state is stabilized. Therefore, if air-fuel ratio feedback control has been started, engine ECU 1000 determines that the combustion state in engine 120 is stable and sets the EGR permission signal to ON (step S046).

On the other hand, if air-fuel ratio feedback control has not been started in step S041, engine ECU 1000 successively determines whether fuel injection control at the time of start has ended or not (step S042). Fuel injection control at the time of start refers to control of a fuel injection amount and fuel injection timing in order to attain excellent starting capability. In actual control, for example, the fuel injection amount at the time of start is increased. Therefore, if fuel injection control at the time of start has ended, engine ECU 1000 determines that the combustion state in engine 120 is stable and sets the EGR permission signal to ON (step S046).

If fuel injection control at the time of start has not ended in step S042, engine ECU 1000 determines whether ignition timing control at the time of start has ended or not (step S043). Ignition timing control at the time of start is configured to retard engine ignition timing relative to the basic ignition timing, for example, in order to suppress occurrence of knocking at the time of start of the engine. Therefore, if ignition timing control at the time of start has ended, engine ECU 1000 determines that the combustion state in engine 120 is stable and sets the EGR permission signal to ON (step S046).

On the other hand, if ignition timing control at the time of start has not ended in step S043, engine ECU 1000 determines whether a prescribed period of time has elapsed since the start (step S044). Here, the prescribed period of time is set based on a period of time until the combustion state in engine 120 is stabilized, that has experimentally been calculated in advance. If the prescribed period of time has elapsed since the start in step S044, engine ECU 1000 sets the EGR permission signal to ON (step S046). On the other hand, if the prescribed period of time has not elapsed since the start in step S044, engine ECU 1000 sets the EGR permission signal to OFF (step S045).

The flowchart in FIG. 7 has been configured to determine that the combustion state in engine 120 is stable if any one of the conditions in steps S041 to S044 is satisfied, however, it may be configured to determine that the combustion state in engine 120 is stable if at least one of these plurality of conditions is satisfied. In addition, conditions for determination are not limited to those in steps S041 to S44, and any condition allowing sensing of a combustion state in engine 120 may be applicable.

In the engine system configuration shown in FIG. 2, engine 120 corresponds to the “internal combustion engine” in the present invention, and the EGR apparatus corresponds to the “exhaust gas recirculation apparatus” in the present invention. In addition, engine ECU 1000 implements the “intermittent operation control means” and the “recirculation gas control means.”

In addition, in the embodiment above, an example in which the control device for the internal combustion engine according to the present invention is mounted on the hybrid vehicle has been described, however, it may be mounted on a vehicle incorporating what is called an economy running system (what is called an eco-run vehicle) forcibly stopping idling of the engine when the vehicle temporarily stops.

Although the present invention has been described and illustrated in detail, it is clearly understood that the same is by way of illustration and example only and is not to be taken by way of limitation, the scope of the present invention being limited only by the terms of the appended claims.

What is claimed is:

1. A control device for an internal combustion engine in a vehicle including the internal combustion engine as a source of driving force, said internal combustion engine including an intake pipe, a recirculation valve and an exhaust gas recirculation apparatus for recirculating a part of exhaust gas into said intake pipe through said recirculation valve, comprising:
an intermittent operation control unit temporarily performing processing for stopping said internal combustion engine in response to a request to stop said internal combustion engine received when a prescribed stop condition is satisfied after start of operation of said vehicle;
a recirculation gas control unit stopping an operation to recirculate the exhaust gas by said exhaust gas recirculation apparatus in response to said request to stop said internal combustion engine; and
a remaining gas amount determination unit determining whether a remaining amount of the exhaust gas within said intake pipe is smaller than a prescribed value;
said intermittent operation control unit performing said processing for stopping said internal combustion engine in response to determination that the remaining amount of the exhaust gas within said intake pipe is smaller than said prescribed value, when said request to stop said internal combustion engine is received.

2. The control device for an internal combustion engine according to claim 1, wherein
said determination unit of the remaining amount of the exhaust gas within said intake pipe estimates the remaining amount of the exhaust gas within said intake pipe at least based on an amount of intake air introduced into said intake pipe.

3. The control device for an internal combustion engine according to claim 2, wherein
said vehicle further includes a source of driving force in addition to said internal combustion engine.

4. The control device for an internal combustion engine according to claim 1, wherein
said intermittent operation control unit start said internal combustion engine when a prescribed stop cancel condition is satisfied, and
said recirculation gas control unit senses a combustion state in said internal combustion engine at start of said internal combustion engine and starts the operation to recirculate said exhaust gas in response to the sensed combustion state being stable.

5. The control device for an internal combustion engine according to claim 4, wherein
said recirculation gas control unit senses the combustion state in said internal combustion engine based on at least one of fuel injection control in said internal combustion engine, ignition timing control in said internal combustion engine, and lapse of time since start of control at the start of said internal combustion engine.

6. The control device for an internal combustion engine according to claim 5, wherein
said vehicle further includes a source of driving force in addition to said internal combustion engine.

7. The control device for an internal combustion engine according to claim 4, wherein
said vehicle further includes a source of driving force in addition to said internal combustion engine.

8. The control device for an internal combustion engine according to claim 1, wherein
said vehicle further includes a source of driving force in addition to said internal combustion engine.
